(19) United States
(12) Patent Application Publication
(10) Pub. No.: US 2008/0027736 A1
(43) Pub. Date: Jan. 31, 2008

(54) MILLIONSAVER - ONLINE BASED CONTACT MANAGEMENT SYSTEM FOR REAL ESTATE INDUSTRY

(76) Inventor: Jan Vanhara, Redohdo Beach, CA (US)

Correspondence Address: JOHN VANHARA, 505 AGATE ST., REDONDO BEACH, CA, 90277, US

(21) Appl. No.: 11/456,277

(22) Filed: Jul. 10, 2006

(51) Int. Cl. G06Q 10/00; G06Q 30/00

(52) U.S. Cl. 705/1

(57) ABSTRACT

The invention is an online based contact management system for real estate industry to create and predict timing of closings, timing of buying process and profile of successful working habits and successful agents. It captures data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios) and it distributes leads based on above specified models to real estate agents for a price based on their productivity. The inventive device includes a software which allows capturing data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios).

### FEDERALLY SPONSORED RESEARCH AND DEVELOPMENT

This invention is not a result of any federally sponsored research and development.

### BACKGROUND OF THE INVENTION

1. Field of the Invention

The present invention relates to an online based contact management system for real estate industry for creating and predicting timing of closings, timing of buying process and profile of successful working habits and successful agents. The leads based on above specified models are distributed to real estate agents.

2. Description of the Related Art

There are many systems which collect data but there is no system specifically for the real estate industry which helps to create and predict timing of closings, timing of buying process and profile of successful working habits and successful agents.

While these systems may be suitable for the particular purpose to which they address, they are not as suitable for creating and predicting timing of closings, timing of buying process and profile of successful working habits and successful agents

In these respects, the online based contact management system for real estate industry according to the present invention substantially departs from the conventional concepts and designs of the existing systems which collect data, and in so doing provides an invention primarily developed for the purpose of creating and predicting timing of closings, timing of buying process and profile of successful working habits and successful agents and to distribute leads based on above specified models to real estate agents.

### SUMMARY OF THE INVENTION

In view of the foregoing disadvantages inherent in the existing systems now present in the prior art, the present invention provides a new online based contact management system for real estate industry wherein the same can be utilized to create and predict timing of closings, timing of buying process and profile of successful working habits and successful agents.

The general purpose of the present invention, which will be described subsequently in greater detail, is to provide a new online based contact management system for real estate industry that has many of the advantages of the existing systems for collecting date and many novel features that result in a new online based contact management system for real estate industry which is not anticipated, rendered obvious, suggested, or even implied by any of the existing systems, either alone or in any combination thereof.

To attain this, the present invention generally comprises software allows capturing data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios). Software captures data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios). The software generates leads based on the date collected. These leads are then distributed to real estate agents for a price based on their respective productivity.

There has thus been outlined, rather broadly, the more important features of the invention in order that the detailed description thereof may be better understood, and in order that the present contribution to the art may be better appreciated. There are additional features of the invention that will be described hereinafter.

The invention is capable of other embodiments and of being practiced and carried out in various ways. Also, it is to be understood that the phraseology and terminology employed herein are for the purpose of the description and should not be regarded as limiting.

A primary object of the present invention is to provide an online based contact management system for real estate industry that will be a solution for efficient and better-organized real estate business.

An object of the present invention is to provide a online based contact management system for real estate industry for create and predict timing of closings, timing of buying process and profile of successful working habits and successful agents and to distribute leads based on above specified models to real estate agents for a price based on their respective productivity.

Another object is to provide an online based contact management system for real estate industry.

Another object is to provide a online based contact management system for real estate industry that has a software which allows capturing data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios).

The invention allows the management of a real estate firm to see who is working on what leads, how many escrow, active buyers/sellers each agent has. The management can finally see what is happening at anytime from anywhere just simply going online. The management has total control about progress, prospecting, active clients and escrows. The management also can check the productivity of individual agents and teams.

Another object is to provide an online based contact management system for real estate industry that enables a group of agents to be assigned to one team and work with the same clients. Assistance can be provided to the clients from different location other than the agent. There is no limit on where or how the software is accessed. Every change in contacts, notes are always time and name stamped. It keeps control on what was done, when and by whom. It maintains a communication log for future use.

The invention helps to determine how to allocate leads and business efficiently.

Other objects and advantages of the present invention will become obvious to the reader and it is intended that these objects and advantages are within the scope of the present invention.

### DETAILED DESCRIPTION OF THE INVENTION

The invention is an online based contact management system for real estate industry, which comprises of a software which allows capturing data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios). The Software is integrated with the website of the Applicant and is completely web based. It is accessible from any computer with Internet connection and Internet Explorer browser. No special downloads are required. Any website where HTML code is placed can transfer data to the software. The captured data is used to create and predict timing of closings, timing of buying process and profile of successful working habits and successful. Leads are automatically entered into the software. The leads based on the captured data are distributed to estate agents for a price based on their respective productivity. The software has easy templates which are customized with client name and other information. Emails are sent directly from the software to clients and the note is entered in notes for communication log.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A claim is made in respect of:
1. An online based contact management system for real estate
2. Software that captures data about requests from customers (repeated requests from websites), model of behavior of users (visits, requests, types of pages visited, frequency of visits), behavior of real estate agents (model of successful agent, including frequency and timing of calls, behavior, time spend working, calling, updating, frequency of contacts, closing ratios) and it distributes leads based on above specified models to real estate agents.
